(19) United States
(12) Patent Application Publication
(10) Pub. No.: US 2023/0367351 A1
(43) Pub. Date: Nov. 16, 2023

(54) CURRENT MIRROR ARRANGEMENT

(71) Applicant: ams-Osram AG, PREMSTAETTEN (AT)

(72) Inventors: Sébastien POIRIER, VALENCIA (ES); Salvador Enrique HOSTALET LEITZKE, VALENCIA (ES)

(73) Assignee: ams-Osram AG, PREMSTAETTEN (AT)

(21) Appl. No.: 18/028,332

(22) PCT Filed: Aug. 31, 2021
(86) PCT No.: PCT/EP2021/073960

§ 371 Date: Mar. 24, 2023

(30) Foreign Application Priority Data
Sep. 30, 2020 (EP) 20199281.5

(51) Int. Cl. G05F 3/26; G05F 1/575; G05F 1/565

(52) U.S. Cl. CPC G05F 3/262; G05F 1/565; G05F 1/575

(57) ABSTRACT

A current mirror arrangement includes an input stage with a series connection of an input mirror transistor and an input cascode transistor between supply terminals. A buffer stage is configured to generate an input control voltage based on an input voltage for a gate terminal of the input mirror transistor, to generate an intermediate control voltage at a replica terminal based on the input voltage and to generate a compensation control voltage based on the input control voltage, the buffer stageincluding a compensation current mirror with an input side connected to a feedback terminal and with an output side being connected to the replica terminal. An output stage includes a compensation stage and a series connection of an output mirror transistor and an output cascode transistor, wherein the compensation stage includes a compensation resistor connected between the replica terminal and an output control terminal that is coupled to a gate terminal of the output mirror transistor, is configured to generate, at the output control terminal, an output control voltage based on the compensation control voltage, and is configured to generate, at a compensation terminal being connected to the feedback terminal, a compensation current based on the compensation control voltage.

### CROSS-REFERENCE TO RELATED APPLICATIONS

This patent application is a national stage entry from International Application No. PCT/EP2021/073960, filed on Aug. 31, 2021, published as International Publication No. WO 2022/069131A1 on Apr. 7, 2022, and claims the priority of European Pat. Application 20199281.5, filed Sep. 30, 2020, the disclosure content of all which are hereby incorporated by reference in their entireties.

### FIELD OF THE INVENTION

The present disclosure relates to a current mirror arrangement.

### BACKGROUND OF THE INVENTION

Current mirrors are widely used for mirroring a given input current to one or more output currents that may have the same current value as the input current or a scaled version thereof with a given scaling factor.

In conventional approaches with field effect transistors as mirror transistors, the gate voltage of a controlling transistor in an input branch is provided to respective gate terminals of controlled transistors in the output branches.

In many applications it is desired that a matching between the output current and the input current is given with a high accuracy. To this end, e.g. buffers are used for stabilizing the control voltages in conventional approaches.

### SUMMARY OF THE INVENTION

An objective to be achieved is to provide an improved mirroring concept that allows an improved matching between input and output in current mirror applications. This objective is achieved with the subject matter of the independent claim. Embodiments and developments of the improved concept are defined in the dependent claims. The improved mirroring concept is based on the insight that load currents in the output branch(es), in particular higher load currents, can result in voltage drops across metal lines from the controlled output transistor(s) to a supply terminal with parasitic resistances. Such voltage drops influence the voltage difference resulting between the gate terminal of the output transistor and the supply terminal, this voltage difference is assumed to be identical to e.g. a gate-source voltage of the output transistor in conventional solutions. According to the improved mirroring concept the control voltage of one or more output transistors of a current mirror is adjusted based on an input control voltage being present at a gate terminal of an input mirror transistor to account for the parasitic voltage drop across the metal lines. This is for example done by shifting a nominal control voltage at the output gate terminal to a slightly higher level by a controlled current through a compensation resistor that preferably matches the output mirror current and the parasitic metal line resistance respectively. Hence, both a gate and a source potential of the output transistor are shifted by a corresponding voltage.

According to preferred implementations, the input mirror transistor and the one or more output mirror transistors may be connected in series to a respective cascode transistor. Different current carrying capabilities between an input side and an output side of the current mirror arrangement may see the accuracy of their ratio improved by level shifting the gate voltages of the cascode transistors in some implementations.

For example, an implementation of a current mirror arrangement according to the improved mirroring concept comprises an input stage, a buffer stage and an output stage. The input stage comprises a series connection of an input mirror transistor and an input cascode transistor coupled between a first and a second supply terminal. The buffer stage is configured to generate an input control voltage based on an input voltage resulting at a first end of the series connection of the input stage and to provide the input control voltage to a gate terminal of the input mirror transistor. The buffer stage is further configured to generate an intermediate control voltage at a replica terminal based on the input voltage and to generate a compensation control voltage based on the input control voltage. The buffer stage comprises a compensation current mirror with an input side connected to a feedback terminal and with an output side being connected to the replica terminal.

The output stage comprises a compensation stage and a series connection of an output mirror transistor and an output cascode transistor with a gate terminal coupled to a gate terminal of the input cascode transistor and to a third supply terminal. For example, the output mirror transistor is connected to the second supply terminal via a parasitic resistance. The compensation stage comprises a compensation resistor connected between the replica terminal and an output control terminal that is coupled to a gate terminal of the output mirror transistor. The compensation stage is configured to generate, at the output control terminal, an output control voltage based on a compensation control voltage, for example, such that a voltage drop from the gate terminal of the output mirror transistor to the replica terminal across the compensation resistor matches a voltage drop from the output mirror transistor to the second supply terminal across the parasitic resistance. The compensation stage is further configured to generate, at a compensation terminal being connected to the feedback terminal, a compensation current based on the compensation control voltage.

Accordingly, during operation of the current mirror arrangement, a current through the compensation resistor from the replica terminal to the output control terminal, respectively the gate terminal of the output mirror transistor, results in a shifting of the intermediate control voltage at the replica terminal to the slightly higher output control voltage at the output mirror transistor. This can compensate for the voltage drop along the metal line resistance caused by the output mirror current. Hence the gate-source voltages at the input mirror transistor and the output mirror transistor match. In order to minimize or compensate for any effects on the replica terminal caused by the current through the compensation resistor, the compensation current flowing back from the compensation terminal to the feedback terminal matches the current through the compensation resistor via the compensation current mirror coupling the feedback terminal with the replica terminal.

For example, for generating the input control voltage based on the input voltage, the buffer stage comprises a first source follower. Furthermore, a second source follower is included for generating the intermediate control voltage based on the input voltage. For example, the first and the second source follower have their control terminals connected together and are provided with the input voltage or a voltage derived from the input voltage. In some implementations, the second source follower has a higher current capability than the first source follower by a first factor. Such current capability is, for example, defined by the amount of current that is driven by the source follower given a certain control voltage. Hence, in the described implementation, the second source follower may drive a current that is higher than the current driven by the first source follower by the first factor. Hence, the first source follower can be dimensioned with a small current consumption while the second source follower has a higher current consumption but less sensitivity to influences from the compensation stage.

In some implementations the compensation stage comprises a first transistor for generating the output control voltage and a second transistor for generating the compensation current. The gate terminals of the first and the second transistor of the compensation stage may be connected together. The first transistor has a higher current capability than the second transistor by a second factor and the output side of the compensation current mirror has a higher current capability than the corresponding input side by the same second factor. Hence, a higher current can be driven by the output mirror transistor while a lower current is needed for the compensation current to the feedback terminal and for the current through the compensation resistor. Hence, the current consumption can be kept low for the compensation.

For example, in such an implementation the buffer stage comprises a series connection of a diode-connected transistor and a transistor being controlled by the input control voltage for generating the compensation control voltage at the gate terminal of the diode-connected transistor. Said series connection of the diode-connected transistor and the transistor being controlled by the input control voltage may be supplied from the third supply terminal. Furthermore, also the first and the second transistor of the compensation stage are supplied from the third supply terminal. Accordingly, the same or similar operating conditions can be established at these transistors.

In some implementations the current mirror arrangement further includes a calibration stage comprising a series connection of a first and a second resistor connected between the third supply terminal and the second supply terminal. In this series connection, the first resistor matches a resistance of the compensation resistor while the second resistor matches a resistance, e.g. a (parasitic) metal resistance, of a connection from the output mirror transistor to the second supply terminal, e.g. forming the parasitic resistance mentioned above. The calibration stage is configured to adjust the generation of the compensation control voltage based on respective voltage drops across the first and the second resistor, e.g. a ratio of the respective voltage drops.

For example, in implementations where the buffer stage comprises a series connection of a diode-connected transistor and a transistor being controlled by the input control voltage, a current capability of the diode-connected transistor can be adjusted or set according to the respective voltage drops across the first and the second resistor. Such an adjustment may, for example, be made in an initial calibration phase such that the setting is made, for example, via one time programmable, OTP, elements. In other implementations, adjustment during operation may be considered. The calibration may achieve the effect that the matching of a voltage drop across the metal line caused by the output current and the voltage drop across the compensation resistor is optimized. This may, for example, be desired if actual resistances deviate from nominal resistances due to process variations.

While the current mirror arrangement has been described in conjunction with a single output stage so far, the improved mirroring concept can be applied also to an arrangement with multiple output stages using the same approach.

For example, the current mirror arrangement further comprises at least one further output stage comprising a further compensation stage and a series connection of a further output mirror transistor and a further output cascode transistor with a gate terminal coupled to the gate terminal of the output cascode transistor. In such an implementation, the further compensation stage comprises a further compensation resistor connected between the output control terminal and a further output control terminal that is coupled to a gate terminal of the further output mirror transistor. The further compensation stage is configured to generate, at the further output control terminal, a further output control voltage based on a compensation control voltage and is configured to generate, at a further compensation terminal being connected to the feedback terminal, a further compensation current based on the compensation control voltage.

Also for the further output stage, a compensation takes place through a voltage drop across the further compensation resistor that is intended to match the voltage drop of the further output current through the metal line resistance. Again, in the buffer stage, the current through the further compensation resistor is matched by the further feedback current.

In the same manner, a plurality of output stages can be added to the current mirror arrangement without loss of generality. In order to selectively activate or deactivate the one or more output stages, the output stage can be made switchable. For example, in some implementations the gate terminal of the output mirror transistor is connected to the second supply terminal or to the source terminal of the output mirror transistor by a first switch and to the output control terminal by a second switch, which for example are to be activated exclusively. Hence, if the first switch is closed, a voltage at the second supply terminal keeps the current path through the output mirror transistor in a non-conducting state, such that it is deactivated. In contrast, if the second switch is closed, the output mirror transistor is controlled by the output control voltage.

In addition or as an alternative, the gate terminal of the output cascode transistor may be connected to the second supply terminal by a first switch and to the third supply terminal by a second switch. Accordingly, a current through the cascode transistor can be blocked or allowed depending on the switch settings of the first and the second switch.

In some implementations the current mirror arrangement further comprises a level shifter stage that is coupled between the gate terminal of the output cascode transistor and the gate terminal of the input cascode transistor. The level shifter stage is configured to generate a shifted voltage from a voltage at the third supply terminal, for example by shifting the voltage at the third supply terminal towards a voltage at the second supply terminal.

For example, a current capability of the one or more output stages is higher than that of the input stage. In such a configuration the same control voltage at the cascode transistors may result in unbalanced currents flowing through the current paths. This effect can be compensated for by the respective shifting of the control voltages.

For example, the level shifter stage is configured to generate the shifted voltage with a voltage difference to the voltage at the third supply terminal that corresponds to a voltage difference between a gate-source voltage of the output cascode transistor and a gate-source voltage of the input cascode transistor, e.g. during operation. Hence, the matching between input and output cascode transistors can be optimized.

In one example implementation the level shifter stage comprises a pair of transistors being connected to the second supply terminal and being controlled by the input control voltage. The level shifter stage further comprises a differential pair of transistors commonly connected to a first transistor of the pair of transistors, wherein a first transistor of the differential pair of transistors is connected between the third supply terminal and the first transistor of the pair of transistors and has its gate terminal connected to the third supply terminal. A second transistor of the differential pair of transistors is connected between an output transistor of a mirror transistor pair and the first transistor of the pair of transistors and has its gate terminal connected to the output transistor of the mirror transistor pair and to the gate terminal of the input cascode transistor.

In such a configuration the mirror transistor pair is supplied from the third supply terminal. An input transistor of the mirror transistor pair is connected to the second transistor of the pair of transistors. The second transistor of the differential pair of transistors has a higher current capability than the first transistor of the differential pair of transistors by a third factor. The input transistor of the mirror transistor pair has a higher current capability than the output transistor of the mirror transistor pair by a fourth factor. Accordingly, a difference in the gate-source voltage of the cascode transistor is compensated by a difference in a gate-source voltage of a differential pair of similar transistors. In this way the drain voltages of the transistors are the same.

The improved mirroring concept can be, for example, used in applications where compatibility with high voltage applications is desired, in particular when combined with larger output currents. For example, the current mirror arrangement can be used for driving piezoelectric actors, e.g. on a selective basis. The implementation variants described above are suitable for fast and accurate high voltage buffering.

### BRIEF DESCRIPTION OF THE DRAWINGS

The improved mirroring concept will be described in more detail in the following with the aid of drawings. Elements having the same or similar function bear the same reference numerals throughout the drawings. Hence their description is not necessarily repeated in following drawings.

In the drawings:

FIG. 1 shows an example implementation of a current mirror arrangement;

FIG. 2 shows a detail of an example implementation of a current mirror arrangement;

FIG. 3 shows an example implementation of a level shifter stage; and

FIG. 4 shows a detail of an example implementation of a calibration stage.

### DETAILED DESCRIPTION

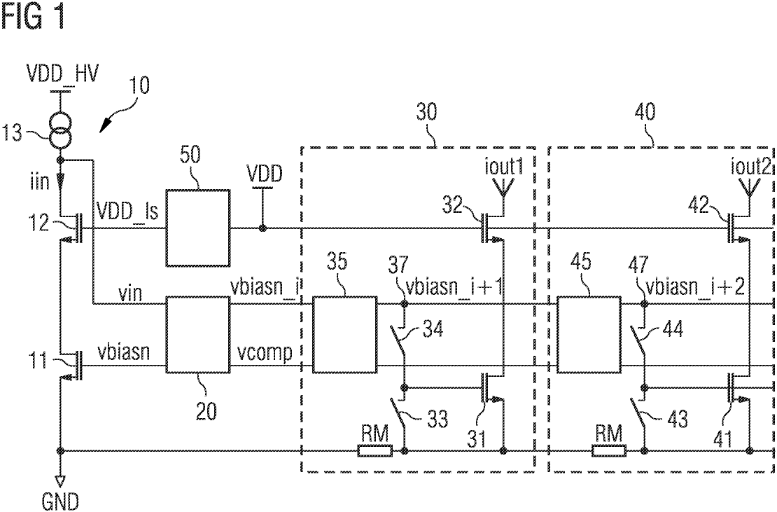

FIG. 1 shows an example implementation of a current mirror arrangement with an input stage 10 and two output stages 30, 40 in this example. Employing more or even less output stages is possible as well and will be explained below in more detail. The input stage 10 comprises a series connection of an input mirror transistor 11 and an input cascode transistor 12 connected in series with a bias current source 13 between a first supply terminal VDD_HV and a second supply terminal GND. An input current iin is flowing from the first supply terminal VDD_HV to the second supply terminal GND such that an input voltage vin results at a first end of the series connection of the input stage 10. In this example implementation, this first end of the series connection of the input stage 10 is directly connected to the bias current source 13, however, including further elements in between is not generally excluded.

The current mirror arrangement further comprises a buffer stage 20 that is provided with the input voltage vin and that is configured to generate an input control voltage vbiasn based on the input voltage vin. The input control voltage vbiasn is provided to a gate terminal of the input mirror transistor 11. The buffer stage 20 is further configured to generate an intermediate control voltage vbiasn_i that is provided to the first output stage 30, in particular to a compensation stage 35 of the first output stage.

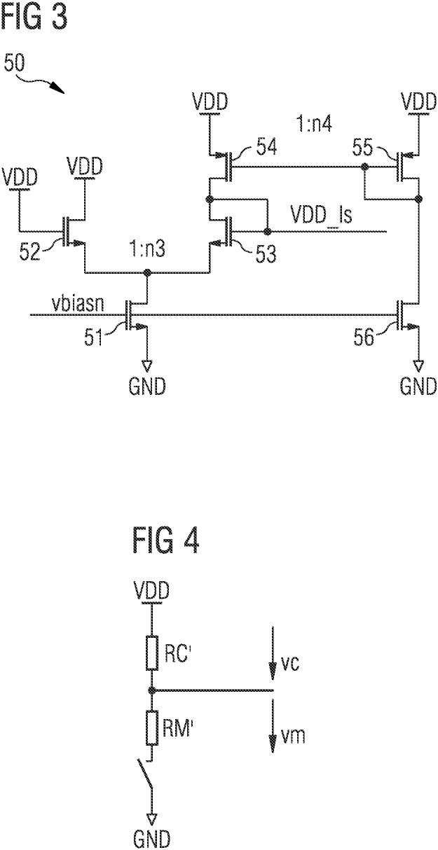

The output stage 30 further comprises a series connection of an output mirror transistor 31 and an output cascode transistor 32 with a gate terminal coupled to a gate terminal of the input cascode transistor 12 and to a third supply terminal VDD. In this example implementation, the gate terminal of the input cascode transistor 12 is coupled to the third supply terminal VDD via an optional level shifter stage 50, the function of which will be explained in more detail in conjunction with FIG. 3. Generally, the level shifter stage 50 may generate a level shifted gate voltage VDD_ls at the gate terminal of the input cascode transistor 12.

The gate terminal of the output mirror transistor 31 is connected in a switchable fashion either to an output control terminal 37 or to its source terminal respectively the second supply terminal GND. To this end, switches 33 and 34 are provided. The compensation stage 35 provides a first output control voltage vbiasn_i+1 at the output control terminal 37. By respective switch settings of the switches 33 and 34, the output branch with output cascode transistor 32 and output mirror transistor 31 can be activated and deactivated, respectively in order to allow an output current ioutl to flow or not.

The source terminal of the output mirror transistor 31 is coupled to the second supply terminal GND by an electrical connection, which in a chip implementation, may be implemented as a metal line having a parasitic supply line metal resistance RM.

The second output stage 40 is implemented in a similar fashion as the first output stage 30. For example, it comprises a series connection of a second output mirror transistor 41 and a second cascode transistor 42 corresponding to the series connection of transistor 31, 32 of the first output stage 30. Furthermore, also the second output stage 40 comprises a compensation stage 45, corresponding to compensation stage 35 of the first output stage 30. The compensation stage 45 receives the first output control voltage vbiasn_i+1 as an input and generates a second output control voltage vbiasn_i+2 at a further output control terminal 47. The compensation control voltage vcomp is also received by the second compensation stage 45. Furthermore, switches 43 and 44 correspond to switches 33 and 34 such that the output branch of the second output stage can be activated or deactivated, respectively, for allowing a second output current iout2 to flow or not. Also for the second output stage 40, there is a parasitic supply line metal resistance RM between the source terminal of the output mirror transistor 41 and the second supply terminal GND.

Further output stages can be connected to the current mirror arrangement in the same way as the second output stage 40 is attached to the first output stage 30. For example, each further output stage has a series connection of a further output mirror transistor and a further output cascode transistor and further comprises a dedicated compensation stage for generating a respective output control voltage based on the output control voltage from a previous output stage and on the compensation voltage vcomp. In addition or as an alternative to switches 33, 34, respectively switches 43, 44, for activating and deactivating the output branch, respectively the output current ioutl, iout2, switches could be added to the gate terminal of the respective output cascode transistor 32, 42 which connect the gate terminal either to the third supply terminal VDD or to the second supply terminal GND.

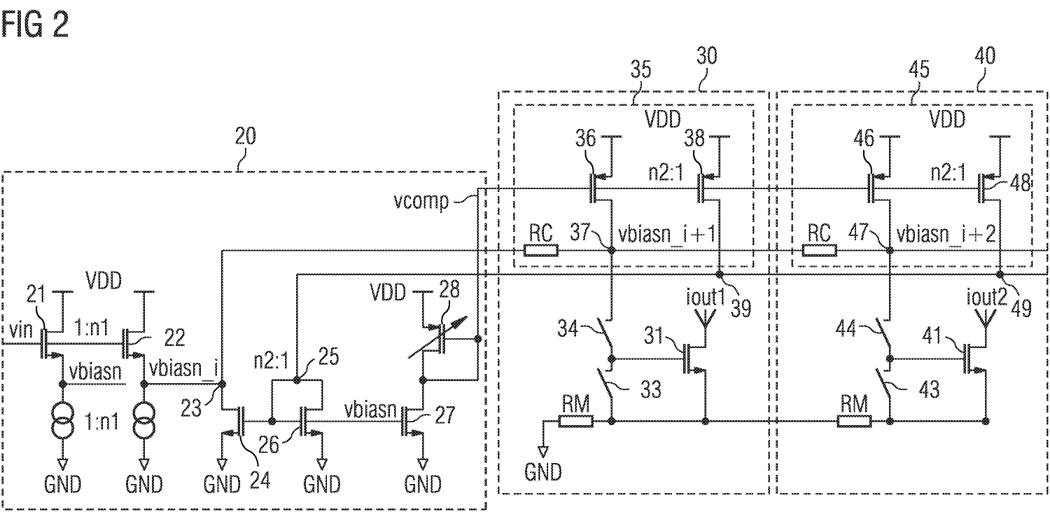

Referring now to FIG. 2, details of an example implementation of a current mirror arrangement are shown. In particular, FIG. 2 shows an example implementation of the buffer stage 20 in connection with a first and a second output stage 30, 40. The buffer stage 20 comprises a first source follower with a transistor 21 connected in series with a current source between the third supply terminal VDD and the second supply terminal GND. The gate terminal of the source follower transistor 21 is provided with the input voltage vin or a voltage derived from the input voltage vin, such that the input control voltage vbiasn results at the source terminal of transistor 21. The buffer stage 20 further comprises a second source follower with a series connection of transistor 22 and a current source connected between the third and the second supply terminal VDD, GND. The gate terminal of the source follower transistor 22 is also provided with the input voltage vin or the voltage derived thereof such that the intermediate control voltage vbiasn_i results at the source terminal of transistor 22. Both the transistors 21 and 22 and the associated current sources are matched to each other with the second source follower having a higher current capability than the first source follower by a first factor n1.

The buffer stage 20 further comprises a compensation current mirror with transistors 24, 26 with transistor 26 being the input of the compensation current mirror connected to a feedback terminal 25 and with transistor 24 forming an output side of the compensation current mirror connected to a replica terminal 23. The replica terminal 23 is also connected to the source terminal of transistor 22 of the second source follower. Transistor 24 has a higher current capability than transistor 26 by a second factor n2.

The buffer stage 20 further comprises a series connection of a diode-connected transistor 28 and the transistor 27 being controlled by the input control voltage vbiasn. In that way the compensation control voltage vcomp is generated at the gate terminal of the diode-connected transistor 28. The series connection of the diode-connected transistor 28 and the transistor 27 is supplied from the third supply terminal VDD.

In the first and the second output stages 30, 40 from the output branches only the respective output mirror transistors 31, 41 with the respective activation and deactivation switches 33, 34 respectively 43, 44 are shown for a better overview. The compensation stages 35, 45 comprise a compensation resistor RC connected between the respective output control terminals 37, 47 and the terminal, at which a previous control voltage is provided. In the case of the first compensation stage 35, this terminal is the replica terminal, at which the intermediate control voltage vbiasn_i is provided. For the second compensation stage 45, said terminal is the output control terminal 37 of the first compensation stage, at which the first output control voltage vbiasn_i+1 is provided. If further output stages are provided, the next output stage would be connected to the second output control terminal 47 etc.

The first compensation stage 35 in this example implementation comprises a first transistor 36 connected between the third supply terminal VDD and the first output control terminal 37, and a second transistor 38 connected between the third supply terminal VDD and a first compensation terminal 39 being connected to the feedback terminal 25. The first and the second transistor 36, 38 are matched to each other while the first transistor 36 has a higher current capability than the second transistor 38 by the second factor n2, which is the same factor as in the compensation current mirror with transistors 24, 26.

In the same fashion, the second compensation stage 45 comprises a first transistor 46 connected between the third supply terminal VDD and the second output control terminal 47 and a second transistor 48 connected between the third supply terminal VDD and a second compensation terminal 49 that is also connected to the feedback terminal 25. Basically, the second output stage 40 with its compensation stage 45 may have the same structure and function as the first output stage 30 with its compensation stage 35.

Transistors 36, 38, 46, 48 and optional transistors of further compensation stages are controlled by the compensation control voltage vcomp.

During operation, the transistor 36 in the first compensation stage 35 generates the first output control voltage vbiasn_i+1 at the first output control terminal 37 and, correspondingly, the transistor 46 in the second compensation stage 45 generates the second output control voltage vbiasn_i+2 at the second output control terminal 47. During operation and assuming that the respective branch is activated by a closed switch 34, the output current ioutl is flowing through the output mirror transistor 31 and through the parasitic supply line metal resistance RM to the second supply terminal GND. Hence, a voltage drop occurs over the resistance RM such that the source terminal of output mirror transistor 31 is slightly higher than the potential at the second supply terminal GND. If the same output control voltage that is used in the input stage was used for controlling the transistor 31, there may be a deviation in the resulting gate-source voltage between input mirror transistor 11 and output mirror transistor 31.

However, due to a corresponding current flow from the first output control terminal 37 to the replica terminal 23 through the compensation resistor RC, a corresponding voltage drop across this compensation resistor RC also results.

Accordingly, the first output control voltage vbiasn_i+1 is also shifted with respect to the intermediate control voltage vbiasn_i. Hence, if the voltage drop across the parasitic resistance RM matches the voltage drop across the compensation resistor RC, the desired gate-source voltage at the output mirror transistor 31 can be established. Accordingly, the output current ioutl assumes a desired value with no or only little deviations.

In order to compensate for the current through transistor 23 in the compensation current mirror, a matched current can flow from the compensation terminal 39 to the feedback terminal 25 such that the intermediate control voltage vbiasn_i is not affected. This increases the accuracy of the arrangement. The same principle applies to the second compensation stage 45 and any further compensation stages, such that in each case a voltage drop across the parasitic resistance RM is compensated by a voltage drop across the corresponding compensation resistor RC.

FIG. 3 refers to a further detail of an example implementation of a current mirror arrangement as described in conjunction with FIG. 1. In particular, FIG. 3 shows a possible implementation of a level shifter stage 50 coupled between the gate terminal of the input cascode transistor 12 and the gate terminals of the output cascode transistor 32 and 42. Generally, the level shifter stage 50 as shown in FIG. 1 is configured to generate a shifted voltage VDD_ls from a voltage at the third supply terminal VDD, for example by shifting the voltage at the third supply terminal VDD towards a voltage at the second supply terminal GND. For example, the level shifter stage generates the shifted voltage VDD_1s with a voltage difference to the voltage at the third supply terminal VDD that corresponds to a voltage difference between a gate-source voltage of the output cascode transistor 32 and a gate-source voltage of the input cascode transistor 12.

In the example implementation of FIG. 3, the level shifter stage 50 comprises a pair of transistors 51, 56 being connected to the second supply terminal GND and being controlled by the input control voltage vbiasn. The level shifter stage 50 further comprises a differential pair of transistors 52, 53 commonly connected to a first transistor 51 of the pair of transistors 51, 56. A first transistor 52 of the differential pair of transistors 52, 53 is connected between a third supply terminal VDD and the first transistor 51 of the pair of transistors 51, 56 and has its gate terminal connected to the third supply terminal VDD. A second transistor 53 of the differential pair of transistors 52, 53 is connected between an output transistor 54 of a mirror transistor pair 54, 55 and the first transistor 51 of the pair of transistors 51, 56.

The second transistor 53 has its gate terminal connected to the output transistor 54 of the mirror transistor pair 54, 55 and to the gate terminal of the input cascode transistor 12, at which the shifted voltage VDD_ls is provided. The mirror transistor pair 54, 55 is supplied from the third supply terminal VDD. An input transistor 45 of the mirror transistor pair 54, 55 is connected to the second transistor 56 of the pair of transistors 51, 56. The second transistor 53 of the differential pair of transistors 52, 53 has a higher current capability than the first transistor 52 of the differential pair of transistors 52, 53 by a third factor n3. The input transistor 55 of the mirror transistor pair 54, 55 has a higher current capability than the output transistor 54 of the mirror transistor pair 54, 55 by a fourth factor n4.

During operation, the difference in the gate-source voltage of the cascode transistors is compensated by a difference in gate-source voltage of the differential pair of similar transistors in the level shifter stage 50. In this way the source voltages of the cascode transistors 12, 32, 42 is the same.

Referring back to FIG. 2, it is aimed at matching the voltage drop across compensation resistor RC to the voltage drop across the parasitic resistance RM. As the exact values of these resistances may not be known in advance, the matching voltage drops can be achieved by, for example, setting the current through the compensation resistor RC, which depends on the compensation control voltage vcomp. To this end, transistor 28 can be provided in an adjustable fashion. Hence, a desired compensation control voltage vcomp may be achieved by calibrating the settings of transistor 28.

For example, the current mirror arrangement comprises a calibration stage comprising the series connection of a first and a second resistor RC′, RM′ connected between the third supply terminal VDD and the second supply terminal GND, as depicted in FIG. 4. The first resistor RC′ may match a resistance of the compensation resistor RC while the second resistor RM′ matches a resistance, e.g. the metal resistance, of the connection from the output mirror transistor 31 to the second supply terminal GND. Accordingly, respective voltage drops vc, vm result from the current between the supply terminals VDD, GND if the switch at the lower end is closed during a calibration phase.

Accordingly, the calibration stage is configured to adjust the generation of the compensation control voltage vcomp based on respective voltage drops vc, vm across the first and the second resistor RC′, RM′, e.g. a ratio of the respective voltage drops vc, vm. The adjustment, for example, can be made by a respective setting of the current capability of transistor 28. This may be performed repeatedly during operation within respective calibration phases, or once after production in a calibration step, wherein the setting is, for example, programmed with one time programmable, OTP, elements.

Through the matching of the compensation current mirror and the respective currents generated therein, a current from the replica terminal 23 to the source terminal of transistor 22 can be fully eliminated thereby reducing any negative influence on the intermediate control voltage vbiasn_i.

It should be noted that in the examples described above NMOS transistors are used in the input stage and the output stages as an example implementation. However, it should be apparent to the skilled person from the above description that the respective NMOS transistors could be easily replaced by respective PMOS transistors while changing respective supply voltage and transistor types of the used transistors.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art and fall within the spirit of the appended claims. The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

1. A current mirror arrangement comprising:
an input stage comprising a series connection of an input mirror transistor and an input cascode transistor connected to a bias current source, coupled between a first and a second supply terminal;
a buffer stage being configured to generate an input control voltage based on an input voltage resulting at a first end of the series connection of the input stage and to provide the input control voltage to a gate terminal of the input mirror transistor, to generate an intermediate control voltage at a replica terminal based on the input voltage and to generate a compensation control voltage based on the input control voltage, the buffer stage comprising a compensation current mirror with an input side connected to a feedback terminal and with an output side being connected to the replica terminal; and
an output stage comprising a compensation stage and a series connection of an output mirror transistor and an output cascode transistor with a gate terminal coupled to a gate terminal of the input cascode transistor and to a third supply terminal, wherein the compensation stage
comprises a compensation resistor connected between the replica terminal and an output control terminal that is coupled to a gate terminal of the output mirror transistor;
is configured to generate, at the output control terminal, an output control voltage based on the compensation control voltage; and
is configured to generate, at a compensation terminal being connected to the feedback terminal, a compensation current based on the compensation control voltage.

2. The current mirror arrangement according to claim 1, wherein the buffer stage comprises a first source follower for generating the input control voltage based on the input voltage and a second source follower for generating the intermediate control voltage based on the input voltage.

3. The current mirror arrangement according to claim 2, wherein the second source follower has a higher current capability than the first source follower by a first factor.

4. The current mirror arrangement according to claim 1, wherein
the compensation stage comprises a first transistor for generating the output control voltage and a second transistor for generating the compensation current;
the first transistor has a higher current capability than the second transistor by a second factor; and
the output side of the compensation current mirror has a higher current capability than the corresponding input side by the second factor.

5. The current mirror arrangement according to claim 4, wherein
the buffer stage comprises a series connection of a diode-connected transistor and a transistor being controlled by the input control voltage (vbiasn) for generating the compensation control voltage at the gate terminal of the diode-connected transistor, said series connection being supplied from the third supply terminal; and
the first and the second transistor of the compensation stage are supplied from the third supply terminal.

6. The current mirror arrangement according to claim 1, further including a calibration stage comprising a series connection of a first and a second resistor connected between the third supply terminal and the second supply terminal (GND), wherein
the first resistor matches a resistance of the compensation resistor;
the second resistor matches a resistance, in particular a metal resistance, of a connection from the output mirror transistor to the second supply terminal (GND); and
the calibration stage is configured to adjust the generation of the compensation control voltage based on respective voltage drops across the first and the second resistor, in particular a ratio of the respective voltage drops.

7. The current mirror arrangement according to claim 1, further comprising at least one further output stage comprising a further compensation stage and a series connection of a further output mirror transistor and a further output cascode transistor with a gate terminal coupled to the gate terminal of the output cascode transistor, wherein the further compensation stage
comprises a further compensation resistor connected between the output control terminal and a further output control terminal that is coupled to a gate terminal of the further output mirror transistor;
is configured to generate, at the further output control terminal, a further output control voltage based on the compensation control voltage; and
is configured to generate, at a further compensation terminal being connected to the feedback terminal, a further compensation current based on the compensation control voltage.

8. The current mirror arrangement according to claim 1, wherein the gate terminal of the output mirror transistor is connected to the second supply terminal or to the source terminal of the output mirror transistor by a first switch and to the output control terminal by a second switch.

9. The current mirror arrangement according to claim 1, wherein the gate terminal of the output cascode transistor is connected to the second supply terminal by a first switch and to the third supply terminal by a second switch.

10. The current mirror arrangement according to claim 1, further comprising a level shifter stage that is coupled between the gate terminal of the output cascode transistor and the gate terminal of the input cascode transistor and is configured to generate a shifted voltage from a voltage at the third supply terminal, in particular by shifting the voltage at the third supply terminal towards a voltage at the second supply terminal (GND).

11. The current mirror arrangement according to claim 10, wherein the level shifter stage is configured to generate the shifted voltage with a voltage difference to the voltage at the third supply terminal that corresponds to a voltage difference between a gate-source voltage of the output cascode transistor and a gate-source voltage of the input cascode transistor.

12. The current mirror arrangement according to claim 10, wherein the level shifter stage comprises
a pair of transistors being connected to the second supply terminal and being controlled by the input control voltage;
a differential pair of transistors commonly connected to a first transistor of the pair of transistors, wherein a first transistor of the differential pair of transistors is connected between the third supply terminal and the first transistor of the pair of transistors and has its gate terminal connected to the third supply terminal, and wherein a second transistor of the differential pair of transistors is connected between an output transistor of a mirror transistor pair and the first transistor of the pair of transistors and has its gate terminal connected to the output transistor of the mirror transistor pair and to the gate terminal of the input cascode transistor; wherein
the mirror transistor pair is supplied from the third supply terminal;
an input transistor of the mirror transistor pair is connected to the second transistor of the pair of transistors;
the second transistor of the differential pair of transistors has a higher current capability than the first transistor of the differential pair of transistors by a third factor; and
the input transistor of the mirror transistor pair has a higher current capability than the output transistor of the mirror transistor pair by a fourth factor.
